(19) United States
(12) Patent Application Publication
(10) Pub. No.: US 2025/0362423 A1
(43) Pub. Date: Nov. 27, 2025

(54) METHOD OF OPTIMIZING FIRST ARRIVAL PICKS IN SEISMIC DATA

(71) Applicant: King Fahd University of Petroleum and Minerals, Dhahran (SA)

(72) Inventors: Ahmed Abdelmoniem Mohamed ELMAK, Dhahran (SA); Wail A. MOUSA, Dhahran (SA); Azzedine Mohamed ZERGUINE, Dhahran (SA); Abdullatif Abdulrahman AL-SHUHAIL, Dhahran (SA)

(73) Assignee: King Fahd University of Petroleum and Minerals, Dhahran (SA)

(21) Appl. No.: 19/074,284

(22) Filed: Mar. 7, 2025

Related U.S. Application Data
(60) Provisional application No. 63/651,519, filed on May 24, 2024.

(51) Int. Cl. G01V 1/32; G01V 1/34

(52) U.S. Cl. CPC G01V 1/325; G01V 1/345; G01V 2210/41

(57) ABSTRACT

A computer-implemented method, and non-transitory computer readable medium for improving the precision of First Arrival (FA) picking in seismic data acquired from vibroseis sources. The method includes determining estimated FA picks using seismic traces and shifting the estimated FA picks to shot points that are within a predetermined window and have highest positive peaks to obtain enhanced FA picks, and then narrowing the enhanced FA picks to refine coherence of trace-to-trace FA picks to obtain accurate FA picks. The accurate FA picks are used to redraw a FA line between FA picks. This redrawn FA line offers an optimized representation of the seismic FA picks, enhancing the accuracy and reliability of seismic data interpretation. The resultant FA line is outputted, thereby providing a sophisticated tool for seismic analysis.

### CROSS-REFERENCE TO RELATED APPLICATIONS

This application claims the benefit of priority to provisional application No. 63/651,519 filed May 24, 2024, the entire contents of which are incorporated herein by reference.

### STATEMENT OF ACKNOWLEDGEMENT

The authors would like to acknowledge the support provided by the Deanship of Scientific Research (DSR) at King Fahd University of Petroleum & Minerals (KFUPM),) Dhahran, Saudi Arabia, for this work.

### BACKGROUND

### Technical Field

The present disclosure is directed to the optimization of First Arrival (FA) picks in seismic data.

### Description Of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Seismic data serves as an important tool in the domain of geophysical exploration, facilitating a comprehensive assessment of subsurface geological structures and properties. This data is derived from the measurement of seismic waves, which are elastic waves generated by various sources such as earthquakes, artificial explosions, or specialized seismic vibrators. The propagation of these waves through the Earth's layers and their subsequent reflection, refraction, or absorption by different geological formations provide valuable insights into the composition, structure, and physical properties of the subsurface. Seismic data acquisition involves deploying an array of sensors (geophones or hydrophones) that record the seismic waves as they return to the surface after interacting with subsurface geological features. The objective of acquiring and analyzing seismic data is to map the geology of the subsurface, which is required for a range of applications, including mineral and hydrocarbon exploration, earthquake seismology, and environmental studies.

Following the acquisition, seismic data undergoes a sophisticated processing workflow designed to enhance the quality of the data and to extract meaningful geological information. A key step in this workflow is the identification of first arrival (FA) picks, which represent the earliest seismic energy arrivals detected by the sensors. These initial signals are pivotal for accurate time-distance measurements and are utilized in constructing detailed subsurface geophysical models.

The methodologies employed for FA picking have evolved significantly, ranging from manual annotation to semi-automatic and fully automated techniques. Manual picking relies on the visual inspection of seismic traces by geophysicists, a method that is both labor-intensive and susceptible to subjective biases. To mitigate these issues and improve efficiency, semi-automatic and automated techniques based on computational algorithms have been developed. Convolutional Neural Networks (CNNs) stand out among automated techniques for their capability to analyze seismic data in the space-time domain effectively. CNN, deep learning algorithms, are particularly adept at processing data with a grid-like topology, such as images or time series. These networks automatically detect patterns and features relevant to FA picking by learning from large datasets of seismic traces, thereby enhancing the accuracy of FA identification.

Multilayer Perceptron (MLPs) are another form of artificial neural networks that utilize the backpropagation algorithm for training. The MLP is a feedforward neural network configured of fully connected neurons. In the context of FA picking, MLPs learn to predict the arrival times of seismic signals by minimizing the difference between the predicted arrival times and the actual arrival times in the training data. This iterative learning process enables MLPs to refine the predictions, resulting in improved precision in FA picking.

Additional techniques, such as the Energy Ratio (ER) method and the Short-Time Average/Long-Time Average (STA/LTA) algorithm, focus on detecting abrupt increases in seismic signal energy, which are indicative of FA signals. The ER technique calculates the ratio of signal energy in a short window to the energy in a longer window, highlighting areas with significant energy increases. Similarly, the STA/LTA method computes the ratio of the average signal amplitude over a short time window to that over a longer time window, identifying segments where the signal intensity abruptly rises.

Despite the abilities of these methodologies, the analysis of seismic data, particularly that generated by vibroseis sources, presents challenges. Vibroseis sources generate seismic signals with a wide range of frequencies, amplitudes, and phase characteristics, producing complex waveforms that complicate FA picking. Therefore, achieving accuracy and reliability of automated and semi-automatic FA identification when the data is generated by vibroseis sources is needed.

To eliminate the challenges corresponding to the vibroseis sources, recent developments emphasized optimization-driven methodologies to enhance the dependability and precision of FAs picking by incorporating diverse optimization criteria, including waveform similarity, coherence, and trace connectivity. Such methods are implemented to enhance the precision and reliability of FA picking by optimizing the selection process based on specific characteristics of the seismic data. However, the complexities associated with vibroseis-generated data necessitate further advancements in these techniques to ensure accurate and reliable analysis of seismic signals.

Accordingly, it is one object of the present disclosure to provide methods and systems for FAs picking for seismic data generated by vibroseis sources, resulting in accurate and reliable seismic data analysis.

### SUMMARY

In an exemplary embodiment, a computer-implemented First Arrival (FA) picking method includes method steps of determining estimated FA picks using a plurality of seismic traces that are generated by a vibroseis source, shifting the estimated FA picks to shot points that are within a predetermined window and have highest positive peaks to obtain enhanced FA picks; optimizing the enhanced FA picks to refine coherence of trace-to-trace FA picks to obtain accurate FA picks, and displaying a plot of the accurate FA picks.

In one aspect, the method includes determining the estimated FA picks within an FA region using various methods, such as Texture-Based Segmentation, Projection Onto Convex sets, and Coppens.

In one aspect, the step of shifting the estimated FA picks further includes locating maximum points in a shot record and measuring distance of the maximum points from first zero or negative points.

In one aspect, the step of shifting the estimated FA picks further includes adjusting the estimated FA picks in accordance with the measured distance to obtain the highest positive peaks.

In one aspect, the step of shifting the estimated FA picks is such that the distance represents 25% of a signal period of a seismic trace.

In one aspect, the step of optimizing the enhanced FA picks further includes receiving consecutive traces of seismic data generated by the vibroseis source, calculating vertical time differences between the enhanced FA picks in the consecutive traces, assessing the vertical time differences, and eliminating the vertical time differences that exceed determined upper or lower limits, selecting a most commonly occurring vertical time difference, and calculating the common slope of the enhanced FA picks based on the selected vertical time difference.

In one aspect, the upper limit is determined by dividing the total number of shot points in a trace (N_{S}) by the number of traces (N_{T}), where the lower limit (Lₗ) is computed by evaluating the vertical time difference between most prominent peaks in consecutive traces within a shot record.

In one aspect, the method further includes assigning the common slope to a first enhanced FA pick in an initial trace, repositioning all subsequent enhanced FA picks based on the common slope derived from the initial trace to determine a revised set of revised FA picks, determining a cumulative sum of the revised FA picks which serves as a shot point score for a corresponding shot point, repeating the assigning, repositioning, and determining for remaining FA picks until all the enhanced FA picks have been scanned and their corresponding cumulative sums have been computed and saved, and selecting a set of enhanced FA picks corresponding to a highest cumulative sum as the accurate FA picks.

In one aspect, the method further includes applying, by the vibroseis source, a sinusoidal vibration of continuously varying frequency during a sweep period.

In one aspect, the predefined window is set to a size to minimize errors during the shifting.

In another exemplary embodiment, a non-transitory computer readable medium having instructions stored therein that, when executed by one or more processor, cause the one or more processors to perform a method of determining estimated FA picks using a plurality of seismic traces that are generated by a vibroseis source, shifting the estimated FA picks to shot points that are within a predetermined window and have highest positive peaks to obtain enhanced FA picks; optimizing the enhanced FA picks to refine coherence of trace-to-trace FA picks to obtain accurate FA picks, and displaying a plot of the accurate FA picks.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates a seismic data collection and analysis system configured to facilitate the mapping of subsurface geological structures, in accordance with an exemplary aspect of the disclosure.

FIG. 1B represents a structured flowchart of conceptual optimization of seismic first arrival (FA) picks, in accordance with an exemplary aspect of the disclosure.

FIG. 2 presents a flowchart of a computer-implemented method for First Arrival (FA) picking, according to certain embodiments.

FIG. 3A depicts the seismic survey data for shot record number 4, according to certain embodiments.

FIG. 3B illustrates the initial FA picks derived from traditional methods, TBS, POCS, and Coppens, as applied to shot record number 4, according to certain embodiments.

FIG. 3C illustrates the substantial increase in accuracy of the FA picks after the application of the present optimization method to the initial estimations from TBS, POCS, and Coppens methods, as applied to shot record number 4, according to certain embodiments.

FIG. 4A represents the primary shot data for shot record number 23, according to certain embodiments.

FIG. 4B illustrates the initial FA picks derived from traditional methods, TBS, POCS, and Coppens, as applied to shot record number 23, according to certain embodiments.

FIG. 4C illustrates the substantial increase in accuracy of the FA picks after the application of the present optimization method to the initial estimations from TBS, POCS, and Coppens methods, as applied to shot record number 23, according to certain embodiments.

FIG. 5 is an illustration of a non-limiting example of details of computing hardware used in the computing system, according to certain embodiments.

FIG. 6 is an exemplary schematic diagram of a data processing system used within the computing system, according to certain embodiments.

FIG. 7 is an exemplary schematic diagram of a processor used with the computing system, according to certain embodiments.

FIG. 8 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a system, a computer-implemented method, and storage medium storing program instructions for optimizing First Arrival (FA) picking in seismic data.

A method of the present disclosure addresses the complexities and challenges associated with the picking of first arrivals (FAs) from seismic data, particularly data generated using vibroseis sources. Despite the existence of automated and semi-automatic methods for FA picking, the requirement for enhanced reliability and precision in FA picking remains unaddressed. The existing technologies rely on optimization-driven methodologies based on criteria, such as waveform similarity, coherence, and trace connectivity. However, the unique challenges posed by vibroseis-generated seismic data, characterized by its complex waveforms with varying frequencies, amplitudes, and phase characteristics, have not been sufficiently addressed.

To overcome the challenges, the present method presents an optimization-based method implemented to enhance the accuracy of FA picking for seismic data obtained from vibroseis sources. The method is based on the use of semi-automatically or automatically estimated FA picks. The method includes the calculation of a common slope from the estimated FA picks, which provides an objective value for each pick. The FA pick with the highest objective value, indicative of its reliability and significance, is selected. The selected FA picks are then utilized to redraw the FA line, ensuring coherence and alignment among all FA picks along a consistent trajectory.

The present method is applied to the vibroseis-generated data. The efficacy of the method of the present disclosure has been substantiated through worldwide collection of shot records, achieving substantial accuracy improvements in shot records 4 and 23 of Yilmaz worldwide assortment of shot records, with enhancements of 48% and 52%, respectively. Yilmaz shot records are published in Oz Yilmaz, Seismic Data Analysis, Society of Exploration Geophysicists, 2001.

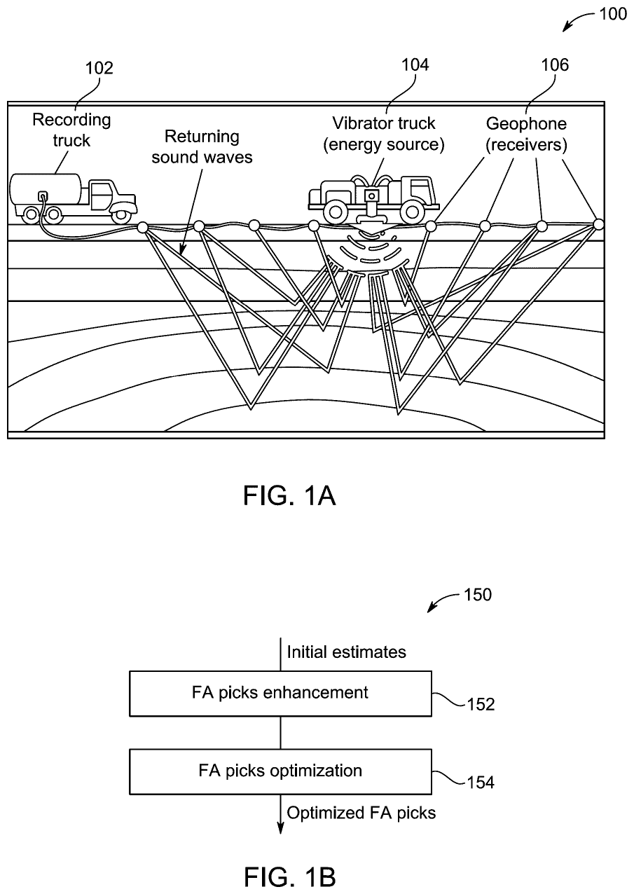

FIG. 1A illustrates a seismic data collection and analysis system configured to facilitate the mapping of subsurface geological structures, in accordance with certain embodiments. Seismic data is a collection of signals that are generated by and reflect off of various geological formations beneath the Earth's surface. These signals are captured as part of geophysical exploration to create images of the subsurface structure, which is essential for applications such as natural resource exploration, understanding geological formations, and assessing potential earthquake risks. The system, herein referred to as system 100, is employed in geophysical exploration to interpret and understand the Earth's subsurface features through the acquisition of seismic data. System 100 is composed of a recording truck 102, a vibrator truck 104 acting as an energy source, and a deployment of geophone receivers 106 distributed across a survey area.

Recording truck 102 functions as a mobile data collection center, configured with a combination of hardware and software designed to receive and process seismic signals. The recording truck 102 includes data acquisition systems that convert received analog seismic signals from geophone receivers 106 into digital data. The recording truck 102 is further configured with a computing systems having one or more processors implemented to the seismic data analysis, and a memory to store extensive seismic data.

One or more processors include a signal processing module, implemented within the recording truck 102, configured for refinement of seismic signals by applying signal processing techniques, such as filtering and amplification.

The recording truck 102 includes a power supply unit to ensure a consistent energy supply to onboard systems, with additional backup power systems for continuity. Communication systems in the recording truck 102 maintain real-time communication with survey teams and enable data transmission to external analysis centers. The recording truck 102 also includes navigation and positioning systems for accurate geographic mapping of the seismic survey.

The seismic data received and processed by the recording truck 102 is sourced from a vibrator truck 104. The signals sourced from vibrator truck 104 are indicative of seismic activity. The vibrator truck 104 is capable of producing seismic waves and send the seismic waves into the subsurface of the earth. The seismic waves reflected off the subsurface are indicative of the seismic activities undergoing beneath the earth surface.

The vibrator truck 104 includes an energy source to generate the seismic waves. In one aspect of the present embodiment, the energy source is a vibroseis energy source. The vibroseis energy source is a type of seismic source used in reflection seismology to generate sound waves that penetrate the Earth's subsurface. The vibroseis energy source consists of a large truck-mounted device that imparts energy to the ground through a plate in contact with the Earth's surface.

The vibrator truck 104 is configured with a plurality of hydraulically controlled vibrators that impart energy into the subsurface strata. The energy generated by the vibroseis energy source is typically provided by the hydraulically controlled vibrators that shake the plate, sending low-frequency vibrations into the ground. Unlike explosive seismic sources that release a single, large burst of energy, a vibroseis source can be controlled to generate waves over a range of frequencies and for extended periods. In one aspect, the hydraulically controlled vibrators apply a controlled force to the ground, which can be adjusted to modify the amplitude and frequency of the seismic waves, enabling the vibrator truck 104 to adapt to varying geological conditions.

The operation of hydraulically controlled vibrators is controllably operated by a control system of the vibrator truck 104, dictating the timing and intensity of the ground vibrations to produce coherent seismic waves. The controlled operation impacts the way seismic waves travel through and interact with the underlying geological formations, resulting in varied reflections and refractions based on the composition and layering of subsurface materials. The energy from vibrator truck 104 travels through various geological formations, with differences in the compositions and densities of these formations affecting the energy's reflection and refraction.

The process of reflected seismic wave collection involves sweeping through a range of frequencies, usually from low to high, over several seconds. This sweep is known as a “chirp,” and it allows geophysicists to tailor the energy input to the specific geological conditions being surveyed. Because the frequency and amplitude of the seismic waves can be precisely controlled, vibroseis sources are particularly useful in populated areas where the use of explosives might be prohibited, or in sensitive environments where minimal disturbance is required.

As the seismic waves are reflected from the subsurface, a plurality of geophone receivers 106 receive the reflected waves. Each geophone receiver 106 converts the kinetic energy of ground movements into electrical signals, which are indicative of the seismic activities of the subsurface structures.

The signal generated by a vibroseis source is recorded by an array of geophones or seismic receivers placed along the surface. By analyzing the time it takes for the sound waves to return to these receivers after reflecting off subsurface geological layers, geophysicists can create detailed images of the subsurface, which are used in oil and gas exploration, mineral prospecting, and for other geological studies.

The signals are transmitted to recording truck 102, where they are compiled and analyzed by a processor to construct a model of the subsurface geography.

FIG. 1B is a flowchart of conceptual optimization of seismic first arrival (FA) picks. The optimization process, at step 150, initiates with obtaining initial estimates, where the preliminary FA picks are established using initial method. At step 152, the FA picks enhancement step is performed. For the enhancement step, the initial estimates are methodically shifted to the shot points exhibiting the strongest signal presence within a predetermined window. The shifting process is similar to the process in which humans manually pick the FAs from seismic data acquired using vibroseis as the energy source.

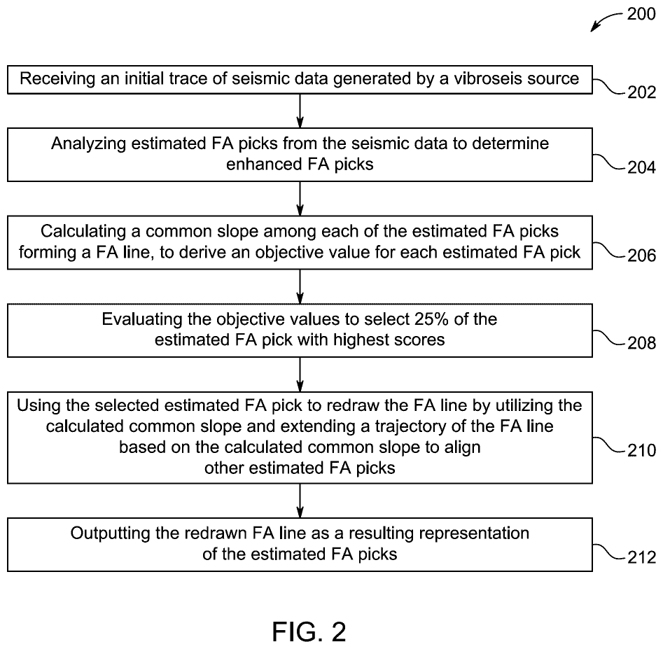

At step 154, the enhanced FA picks are optimized. The optimization results in refining the enhanced FA picks by evaluating the correlation between seismic traces, thereby narrowing and/or optimizing the accuracy of the FA picks. After the optimization process, the optimized FA picks represent the outcome of this systematic approach. Each step corresponds to a strategic component of the technique aiming to enhance the precision of FA picks in seismic data analysis. An implementation of the process is described in detail with reference to FIG. 2.

FIG. 2 is a flowchart of a computer-implemented method for First Arrival (FA) picking, illustrating a sequence of operations for analyzing seismic data obtained from a vibroseis source, in accordance with certain embodiments. The FA picking is a process used in seismic data analysis to identify the first instance when seismic waves, generated by a source and transmitted through the Earth's subsurface, are detected by a receiver after traveling directly through the subsurface layers. These initial seismic signals, or FAs, are the first energy arrivals on a seismic trace and are crucial for seismic data interpretation. As known in the field of seismology, a seismic trace refers to the recorded digital curve from a single seismograph when measuring ground movement.

In seismic exploration, accurate FA picking is fundamental for a variety of applications, including calculating the velocity of seismic waves through the subsurface and constructing accurate images of the subsurface geology. These images can help identify potential locations of oil, gas, minerals, and other geological formations.

In one aspect, the FA picking is automatic. Automated methods often involve signal processing techniques to enhance the seismic trace and analyse the FA against the background noise and later seismic arrivals. The precision of FA picking can significantly affect the quality of the subsequent interpretation and the accuracy of the geological models derived from the seismic data.

At step 202, an initial seismic trace of seismic data, generated by a vibroseis source, is received. As discussed later, the initial seismic trace serves as a basis for an alignment procedure. In particular, later subsequent picks are repositioned based on the slope derived from the initial seismic trace. This initial seismic data may be captured by the plurality of geophone receivers 106 and transmitted to the recording truck 102 for further processing.

The process of initial estimation of FA picks includes using any suitable FA picking method to identify picks within the FA region. Step 202 thus initiates the subsequent optimization. The enhancement of the accuracy of the FA picks is achieved through the application of the method of the present disclosure. The FA picking is performed by utilizing one or more first arrival-picking methods. Examples of such methods include, but may not be limited to, Texture-Based Segmentation (TBS), Projection Onto Convex Sets (POCS), Coppens, and a combination of such methods thereof.

In step 204, the method includes analyzing the estimated FA picks from the seismic data to ascertain enhanced FA picks. During the analysis, the computing system within recording truck 102 utilizes an algorithm to evaluate the seismic signals received, identifying the initial seismic energy that the geophone receivers 106 have detected.

Step 206 involves calculating a common slope among each of the estimated FA picks to form an FA line. By analyzing the FA picks estimated at step 204, a common slope for the estimated FA picks is calculated. The calculation of this common slope is performed to derive an objective value for each estimated FA pick. The process of calculating a common slope is similar to the process of manually applying statistical methods to determine the strongest set of initial FA picks, establishing a quantitative measure of the accuracy.

At step 208, the objective values obtained from the previous step are assessed to select the highest 25% cumulative sum of the estimated FA picks. By assessing the objective values, the FA picks with higher scores are identified as FA picks having high reliability and significance. This identification prioritizes the FA picks that most reliably represent the first seismic arrivals.

In this method, computerized selection of First Arrival (FA) picks is based on predefined criteria, which may lead to the identification of shot points that are not as prominent as those chosen by human experts, yet remain within the First Arrival region. To enhance these initial picks, a procedure known as FA Picks Enhancement is implemented. This enhancement process ensures that the picks are aligned with the most significant positive peaks within a predetermined window. A small window size is deliberately utilized to reduce errors when relocating the estimated picks.

The enhancement procedure involves shifting the estimated FA picks to the peaks that exhibit the highest amplitudes within the duration of the signal trace. This duration is determined by identifying the maximum points on a shot record and calculating the distance to the initial zero or negative points, referred to as di. This distance di signifies 25% of the signal period, represented as Sₚ, which acts as the window utilized to enhance the FA picks. A seismic shot record shows seismic curve traces, usually for a single shot spread, from a seismic recording system, or seismograph. Following this determination, the FA picks g_{FAP}(nₜ, nₓ) within a shot record g(nₜ, nₓ) is adjusted relative to this distance, leading to the emergence of distinct positive peaks, which are then identified as g_{E}(nₜ, nₓ), the enhanced FA picks. A shot record includes a time nₜ and offsett nₓ.

The FA picks enhancement algorithm is presented in the pseudocode given below:

```
Calculate gE (nₜ, nₓ)
Require: gF AP (nₜ, nₓ), g(nₜ, nₓ)
Ensure: gE (nₜ, nₓ) ← gF AP (nₜ, nₓ)
  y ← max (g(nₜ, nₓ))
  dᵢ ← min (g(nₜ, nₓ) ≤ 0) ≈ y
  Sₚ ← 4 x dᵢ
  while g_{FAP} (nₜ, nₓ) = EMPTY do
    Take the current pick gFAP (nₜᵢ , nₓⱼ )
    gₜ(nₜi , nₓj ) max g_{FAP} (nₜi 4←dᵢ, nₓj )
  if gₜ(nₜi , nₓj ) = g_{FAP} (nₜi , nₓj )
  then ± X
    gE (nₜi , nₓj ) ←g_{FAP} (nₜi , nₓj )
    Disp: ”FA pick already correlates to the strongest positive peak.”
  else
    gE (nₜi , nₓj ) ←gₜ(nₜi , nₓj )
    Disp: ”FA pick has been effectively modified.”
  end if
end while
```

Where g(nₜ, nₓ) represents a seismic shot record, g_{FAP}(nₜ, nₓ) denotes the initially estimated FA picks vector, g_{E}(nₜ, nₓ) is the enhanced FA picks vector, Sₚ refers to the signal period or window length (equivalent to four times dᵢ), and g(nₜ_{ᵢ}, nₓ_{ⱼ}) signifies the peak for the FA pick at a trace with offset nₓ_{ⱼ} and initially located at nₜ_{ᵢ}.

With the most reliable FA picks selected, step 210 uses the selected FA picks to redraw the FA line by utilizing the calculated common slope. The FA line is extended to align other estimated FA picks, ensuring they all adhere to a coherent path, which is initiated from the selected estimated FA pick. This step ensures consistency and coherency among all estimated FA picks relative to the subsurface geological structures that the seismic waves have encountered.

After shifting the FA picks to correspond with the most significant positive peaks at step 208, the process for the shifted FA picks is performed at step 210. Processing of the FA picks is for enhancing the coherence of the trace-to-trace picks and refining the accuracy of the picks across sequential traces, aligning them in an almost straight line. By ensuring that the FA picks between adjacent traces share a consistent slope, the method facilitates the removal of incorrectly selected peaks, thereby improving the precision of FA picking.

Step 212 outputs the redrawn FA line as a resulting representation of the enhanced FA picks. The redrawn FA line, enhanced and refined linear representation of FA picks, depicts a more accurate indication of the geophysical characteristics of the subsurface formations, as detected by the seismic data collection system.

At this step, the implementation assumes that all of the enhanced FA picks are acceptable. This assumption implies that even the picks that match with irrelevant FA picks are utilized in the process. The initial stage of the optimization procedure, as detailed in the pseudocode for Algorithm 2, involves calculating the time differences in the vertical direction between the FA picks of successive traces. Such vertical differences are then examined, and any that surpass the pre-established upper or lower limit values are discarded.

ALGORITHM 2:

```
Calculate g_{OP} (nt, nx)
Require: g_{FA} (nt, nx), gE (nt, nx)
Ensure: g_{OP} (nt, nx) ← gE (nt, nx)
  vd(nt, nxj ) ← gE(nt, nxj ) − gE (nt, nxj+1 )
  vd ← mode vd (nt, nxj)
  S_{FAP} ← vd + 1
  while gE (nt, nx) EMPTY do
      Take the m^{th} pick gE (nₜᵢ, nₓₘ)
      gt(nₜᵢ , nₓⱼ ) ← gΣE (nₜᵢ ± m + j ± S_{FAP} , nₓⱼ )
      Cₛ(nₜᵢ , nₓⱼ) = gₜⱼ (nₜ, nₓ) g_{FA}(nₜ, nₓ)
      if Cₛ (nₜᵢ, nₓⱼ) ≥ Cₛ(nₜᵢ, nₓⱼ−1 ) then
        g_{OP} (nₜ, nₓ) ← Cₛ(nₜᵢ , nₓⱼ)
        Disp: ”Better optimized FA picks are identified and effectively
        patched.”
  else
        g_{OP} (nₜ, nₓ) ←Cₛ(nₜᵢ, nₓⱼ₋₁)
        Disp: ”Pre-selected FA picks are preferable.”
      end if
    end while
```

The upper limit is determined by dividing the total number of shot points in a trace (N_{S}) by the number of traces (N_{T}), as defined by the following equation:

$${L}_{u} = \frac{{N}_{S}}{{N}_{T}} . \qquad ( 1 )$$

Meanwhile, the lower limit (Lₗ) is computed by evaluating the vertical difference between the most prominent peaks in consecutive traces within a shot record, typically excluding FA picks. Once the lower limit and upper limit values have been determined, any vertical differences between enhanced FA picks above Lᵤ or below Lₗ are eliminated. Subsequently, the most commonly occurring vertical difference (v_{d}) is selected. This value is then utilized to calculate the slope of the FA picks (SF AP) using the Pythagorean theorem, as defined by the following formula:

$${S}_{FAP} = \sqrt{{v}_{d}^{2} + 1} . \qquad ( 2 )$$

After determining the slope, the optimization procedure applies the slope to the first improved FA pick of the series. This initial application sets a precedent, and subsequent FA picks are then aligned according to the established slope from the initial seismic trace. This alignment produces a new set of FA picks. For each FA pick, a cumulative score is calculated, reflecting the summation of the adjusted picks' values. The aforementioned optimization process is repeated for the remaining picks until all the enhanced FA picks have been scanned and their corresponding cumulative sums have been computed and saved. Upon completion of the sequence, the optimized set of FA picks associated with the highest cumulative score is identified and selected, representing the most accurate FA picks.

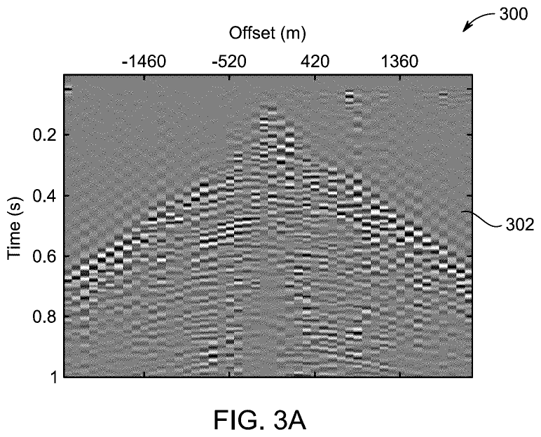

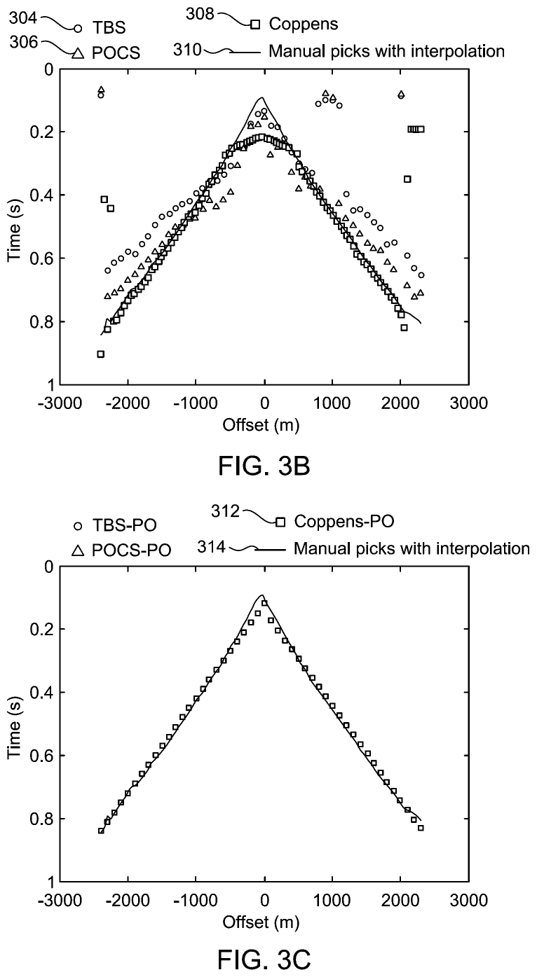

FIG. 3A depicts the seismic survey data for shot record number 4 of Yilmaz worldwide assortment of shot records, in accordance with certain embodiments. The record is part of an evaluation to determine the effectiveness of the proposed first arrival (FA) picking method using data from vibroseis sources. The data represented by pattern 402 has been recorded with a temporal resolution of 4 milliseconds and a spatial resolution of 100 meters. These specific sampling intervals are referenced from a global collection of shot records.

FIG. 3A provides the baseline data for the FA picking assessment. The baseline data is the initial framework upon which the TBS, POCS, and Coppens FA picking methods are applied. The clarity and granularity of this seismic data 302 impacts the accuracy FA determination and set the stage for demonstrating the improvements offered by the proposed method.

FIG. 3B illustrates the initial FA picks derived from three distinct methods, TBS, POCS, and Coppens, as applied to shot record number 4 of Yilmaz worldwide assortment of shot records. The TBS method is represented by curve 304, the POCS method is represented by curve 306, and the Coppens method is represented by curve 308. The picks are plotted against the seismic data to provide an assessment of their initial positioning and accuracy. Curve 310 represents manual picks with interpolation. An expert geophysicist's actual picks, referred to as manual picks, served as a benchmark to evaluate the accuracy of each method within an absolute error margin of 20 milliseconds. The Coppens method attained the highest initial accuracy with 45.83%, followed by POCS at 37.5% and TBS at 14.58%, as detailed in Table 1. Despite the variances, all methods yielded picks that fell within the designated FA region, underscoring the potential for accuracy enhancement.

TABLE 1
Assessment Of Pick Accuracy for Vibroseis Data Using
Different Estimation Methods: Comparison with Manual
Reference Picks Within ±20 ms tolerance Window

| Method | Shot Record (4) | Shot Record (23) |
|---|---|---|
| TBS | 14.58% | 33.33% |
| Coppens | 45.83% | 37.5% |
| POCS | 37.5% | 27.08% |

FIG. 3C illustrates the substantial increase in accuracy of the FA picks after the application of the present method to the initial estimations from TBS, POCS, and Coppens methods. The curve representing the Coppens method is shown by curve 312. The picks are plotted against the seismic data to provide an assessment of their initial positioning and accuracy. Curve 314 represents manual picks with interpolation. The processed picks, now displayed with enhanced alignment and consistency, signify a notable advancement in precision, reaching an accuracy of 81.25% within the 20 millisecond tolerance window. The improved accuracy is a significant improvement from the initial estimates, showcasing increments of over 66% for TBS, 43% for POCS, and 35% for Coppens. These enhancements, enumerated in Table 2, present the effectiveness of the method of the present disclosure as an alternative to traditional seismic FA picking techniques.

TABLE 2
Evaluating Pick Accuracy For Optimized Fa Picks: Comparing
To Manual Reference Picks Within A ±20 ms Tolerance Window

| Method | Shot Record (4) | Shot Record (23) |
|---|---|---|
| TBS | 81.25% | 85.4167% |
| Coppens | 81.25% | 85.4167% |
| POCS | 81.25% | 85.4167% |

The disclosed method uses two vibroseis-sourced real-shot records to validate the accuracy and efficiency of the proposed FA picking method. The seismic data is characterized by its finely sampled intervals, which are crucial for detailed seismic analysis and accurate FA picking. Specifically, the data boasts a temporal sampling interval of 4 milliseconds and a spatial sampling interval of 100 meters, as sourced from the comprehensive worldwide assortment of shot records.

FA picks obtained using three different methods: TBS, POCS, and Coppens, are utilized as the initial estimations for the process of the present disclosure. The quality of the seismic data, with its high resolution and precise interval measurements, provides a solid foundation for the subsequent application of FA picking methods and demonstrates the proposed method's potential for enhancing accuracy in the context of complex vibroseis-sourced data.

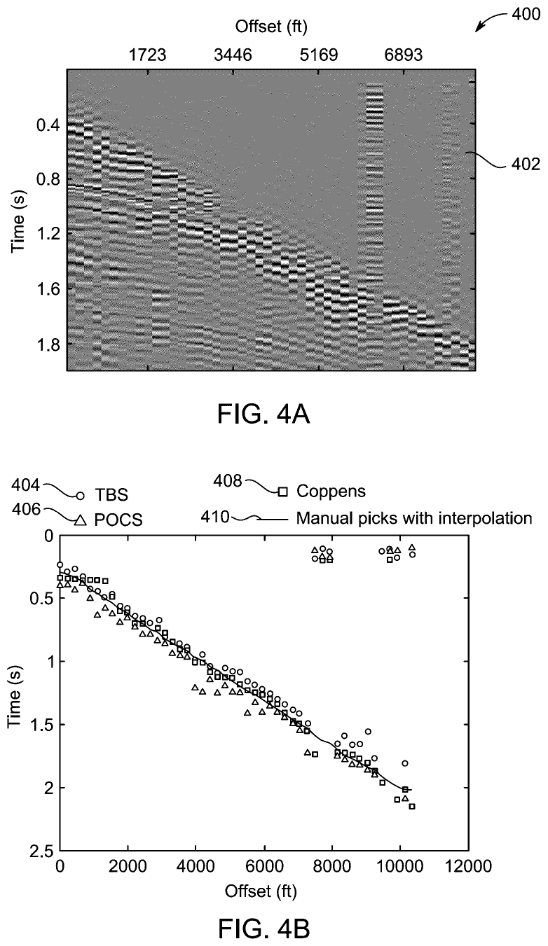

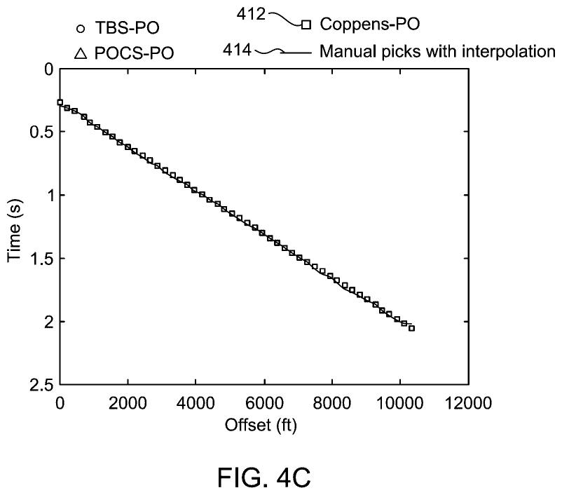

FIG. 4A represents the primary shot data for shot record number 23 of Yilmaz worldwide assortment of shot records, used in the evaluation of the proposed FA picking method. This seismic survey data is characterized by its fine temporal resolution of 2 milliseconds and spatial resolution of 220 feet, offering a detailed substrate for the application of FA picking methods. The figure sets the stage for the initial FA picks by providing a clear visualization of the seismic waveform data as sourced from the global collection.

FIG. 4B represents the initial FA picks determined through traditional methods. The traditional methods including TBS, Coppens, and POCS are visualized. The graphical illustration provides each method performed on shot record number 23 of Yilmaz worldwide assortment of shot records, prior to the application of the proposed optimization technique. Curve 404 represents TBS method, curve 406 represents POCS method, and curve 408 represents Coppens method. Curve 410 represents manual picks with interpolation. The FA picks are displayed against the backdrop of the seismic data, resulting in an assessment of the initial accuracy of the methods as in Table 1.

FIG. 4C illustrates the FA picks after the application of the present optimization technique. The visualization demonstrates the substantial improvement in accuracy, with the FA picks appearing more aligned and coherent, indicating enhanced precision. Curve 412 represents Coppens method and a curve 414 represents manual picks with interpolation. The figure visually represents the efficacy of the proposed method, as quantified in Table 2, which details the accuracy enhancements of over 52% for TBS, 47% for Coppens, and 58% for POCS methods.

Together, FIG. 4A-FIG. 4C illustrate a process and results of applying the disclosed method to shot record number 23 of Yilmaz worldwide assortment of shot records, from the initial raw data and FA picks to the refined and optimized picks. These figures clearly demonstrate the significant enhancements in FA picking accuracy achieved through the disclosed method, reinforcing its value in seismic data analysis.

The method of the present disclosure thus refines the accuracy of first arrival (FA) picking procedures specifically for data obtained from vibroseis sources. By using conventional FA picking methods as a preliminary step and then applying the enhancement technique, the precision of seismic FA picking is significantly honed. The efficiency of the method was verified by applying it to the vibroseis-generated seismic data, where it demonstrated an accuracy enhancement of 50%. The method of the present disclosure presents substantial advancement for improving FA pick precision in the realm of vibroseis-generated seismic data and holds promise for enhancing the dependability of FA detection.

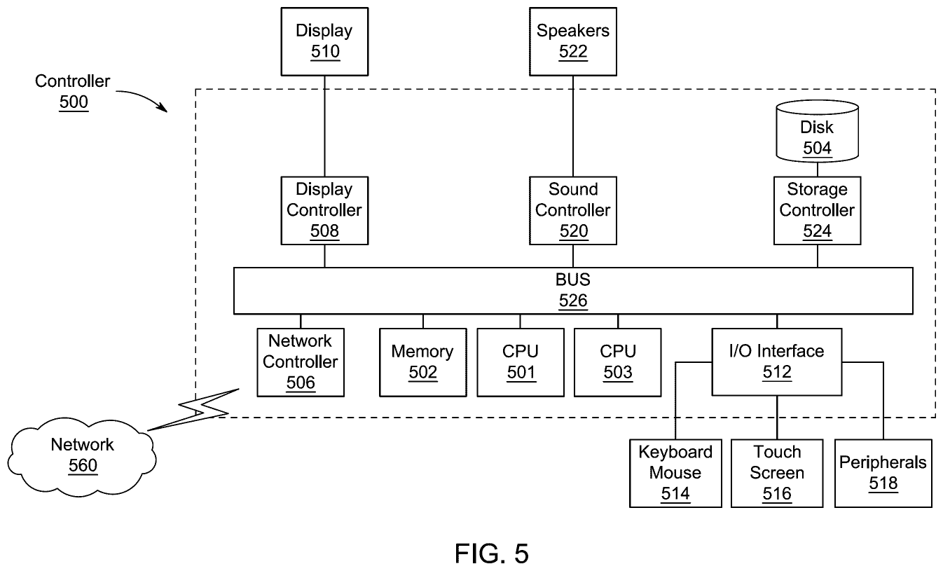

Next, further details of the hardware description of the computing environment according to exemplary embodiments is described with reference to FIG. 5. In FIG. 5, a controller 500 is described in which the controller is a computing device which includes a CPU 501 which performs the processes described herein. The process data and instructions may be stored in memory 502. These processes and instructions may also be stored on a storage medium disk 504 such as a hard drive (HDD) or portable storage medium or may be stored remotely.

Further, the present disclosure is not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the present disclosure may be provided as a utility application, background daemon, or component of an operating system, or combination thereof, executing in conjunction with CPU 501, 503 and an operating system such as Microsoft Windows, UNIX, Solaris, LINUX, Apple MAC-OS and other systems known to those skilled in the art.

The hardware elements in order to achieve the computing device may be realized by various processing circuitry elements, known to those skilled in the art. For example, CPU 501 or CPU 503 may be a Xenon or Core processor from Intel of America or an Opteron processor from AMD of America, or may be other processor types that would be recognized by one of ordinary skill in the art. Alternatively, the CPU 501, 503 may be implemented on an FPGA, ASIC, PLD or using discrete logic circuits, as one of ordinary skill in the art would recognize. Further, CPU 501, 503 may be implemented as multiple processors cooperatively working in parallel to perform the instructions of the inventive processes described above.

The computing device in FIG. 5 also includes a network controller 506, such as an Intel Ethernet PRO network interface card from Intel Corporation of America, for interfacing with network 560. As can be appreciated, the network 560 can be a public network, such as the Internet, or a private network such as an LAN or WAN network, or any combination thereof and can also include PSTN or ISDN sub-networks. The network 560 can also be wired, such as an

Ethernet network, or can be wireless such as a cellular network including EDGE, 3G, 4G, 5G and 6G wireless cellular systems. The wireless network can also be WiFi, Bluetooth, or any other wireless form of communication that is known.

The computing device further includes a display controller 508, such as a NVIDIA GeForce GTX or Quadro graphics adaptor from NVIDIA Corporation of America for interfacing with display 510, such as a Hewlett Packard HPL2445w LCD monitor. A general purpose I/O interface 512 interfaces with a keyboard and/or mouse 514 as well as a touch screen panel 516 on or separate from display 510. General purpose I/O interface also connects to a variety of peripherals 518 including printers and scanners, such as an OfficeJet or DeskJet from Hewlett Packard.

A sound controller 520 is also provided in the computing device such as Sound Blaster X-Fi Titanium from Creative, to interface with speakers/microphone 522 thereby providing sounds and/or music.

The general purpose storage controller 524 connects the storage medium disk 504 with communication bus 526, which may be an ISA, EISA, VESA, PCI, or similar, for interconnecting all of the components of the computing device. A description of the general features and functionality of the display 510, keyboard and/or mouse 514, as well as the display controller 508, storage controller 524, network controller 506, sound controller 520, and general purpose I/O interface 512 is omitted herein for brevity as these features are known.

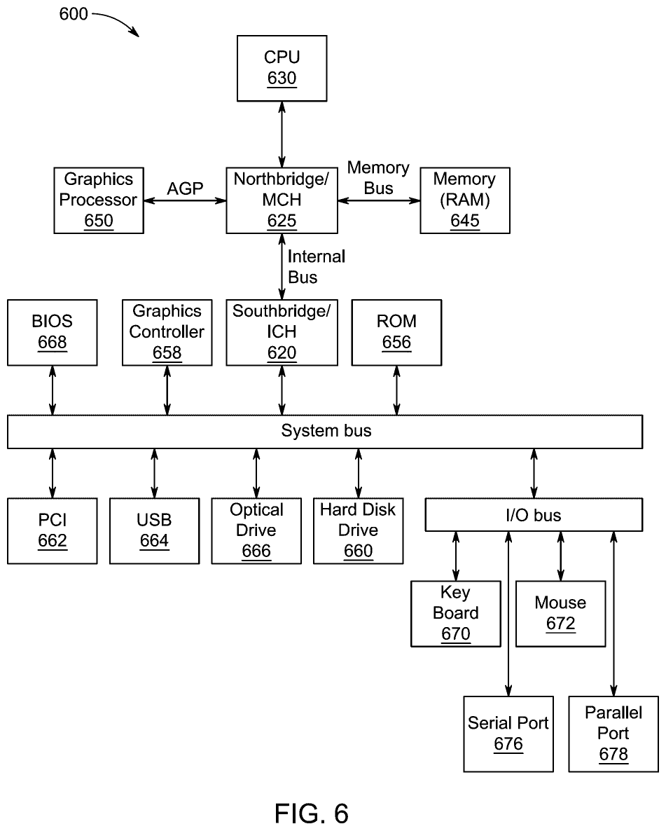

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 6.

FIG. 6 shows a schematic diagram of a data processing system, according to certain embodiments, for performing the functions of the exemplary embodiments. The data processing system is an example of a computer in which code or instructions implementing the processes of the illustrative embodiments may be located.

In FIG. 6, data processing system 600 employs a hub architecture including a north bridge and memory controller hub (NB/MCH) 625 and a south bridge and input/output (I/O) controller hub (SB/ICH) 620. The central processing unit (CPU) 630 is connected to NB/MCH 625. The NB/MCH 625 also connects to the memory 645 via a memory bus, and connects to the graphics processor 650 via an accelerated graphics port (AGP). The NB/MCH 625 also connects to the SB/ICH 620 via an internal bus (e.g., a unified media interface or a direct media interface). The CPU Processing unit 630 may contain one or more processors and even may be implemented using one or more heterogeneous processor systems.

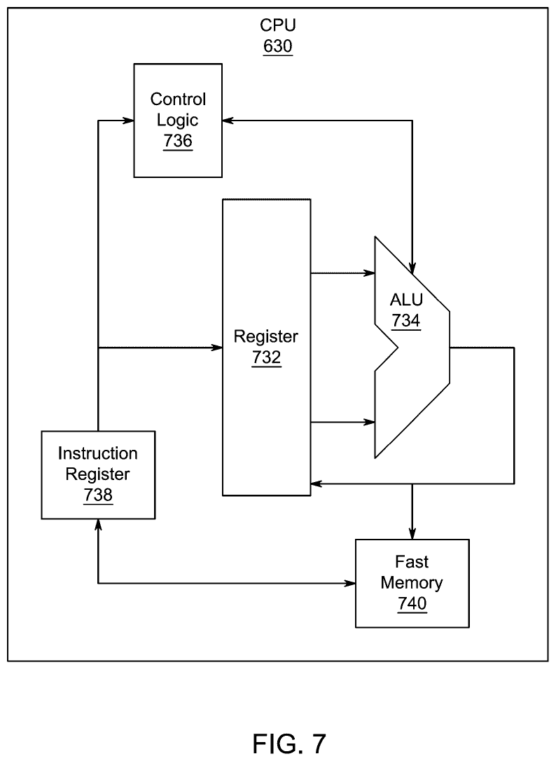

For example, FIG. 7 shows one implementation of CPU 630. In one implementation, the instruction register 736 retrieves instructions from the fast memory 740. At least part of these instructions are fetched from the instruction register 736 by the control logic 736 and interpreted according to the instruction set architecture of the CPU 630. Part of the instructions can also be directed to the register 732. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 734 that loads values from the register 732 and performs logical and mathematical operations on the loaded values according to the instructions. The results from these operations can be feedback into the register and/or stored in the fast memory 740. According to certain implementations, the instruction set architecture of the CPU 630 can use a reduced instruction set architecture, a complex instruction set architecture, a vector processor architecture, a very large instruction word architecture. Furthermore, the CPU 630 can be based on the Von Neuman model or the Harvard model. The CPU 630 can be a digital signal processor, an FPGA, an ASIC, a PLA, a PLD, or a CPLD. Further, the CPU 630 can be an x66 processor by Intel or by AMD; an ARM processor, a Power architecture processor by, e.g., IBM; a SPARC architecture processor by Sun Microsystems or by Oracle; or other known CPU architecture.

Referring again to FIG. 6, the data processing system 600 can include that the SB/ICH 620 is coupled through a system bus to an I/O Bus, a read only memory (ROM) 656, universal serial bus (USB) port 664, a flash binary input/output system (BIOS) 668, and a graphics controller 658. PCI/PCIe devices can also be coupled to SB/ICH 688 through a PCI bus 662.

The PCI devices may include, for example, Ethernet adapters, add-in cards, and PC cards for notebook computers. The Hard disk drive 660 and CD-ROM 666 can use, for example, an integrated drive electronics (IDE) or serial advanced technology attachment (SATA) interface. In one implementation the I/O bus can include a super I/O (SIO) device.

Further, the hard disk drive (HDD) 660 and optical drive 666 can also be coupled to the SB/ICH 620 through a system bus. In one implementation, a keyboard 670, a mouse 672, a parallel port 678, and a serial port 676 can be connected to the system bus through the I/O bus. Other peripherals and devices that can be connected to the SB/ICH 620 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended backup load to be powered.

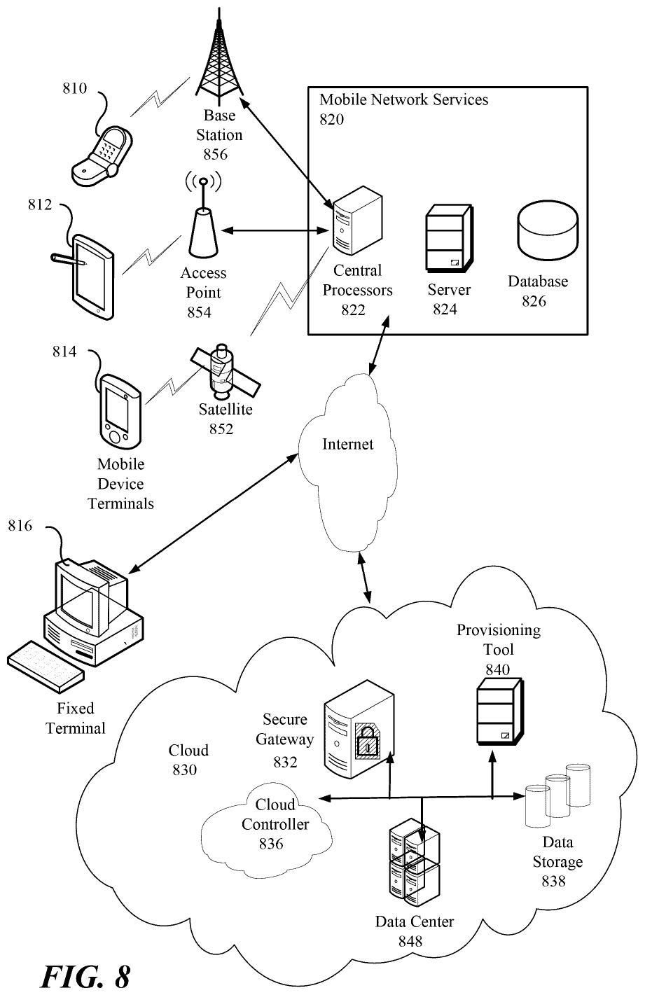

The functions and features described herein may also be executed by various distributed components of a system. For example, one or more processors may execute these system functions, wherein the processors are distributed across multiple components communicating in a network. The distributed components may include one or more client 816 and server machines 822, 824, which may share processing, as shown by FIG. 8, in addition to various human interface and communication devices (e.g., cellular phones 810 via base station 856, smartphones 814 via satellite 852, tablets 812 via access point 854, and personal digital assistants (PDAs)) via mobile network services 820 and database 826. The network may be a private network, such as a LAN or WAN, or maybe a public network, such as the Internet (Cloud 830, secure gateway 832, data center 834, cloud controller 836, data storage 838, provisioning tool 840. Input to the system may be received via direct user input and received remotely either in real-time or as a batch process. Additionally, some implementations may be performed on modules or hardware not identical to those described. Accordingly, other implementations are within the scope of the present disclosure.

The above-described hardware description is a non-limiting example of a corresponding structure for performing the functionality described herein.

Numerous modifications and variations of the present disclosure are possible in light of the above teachings. It is therefore to be understood that the invention may be practiced otherwise than as specifically described herein.

1. A computer-implemented First Arrival (FA) picking method, comprising:
determining estimated FA picks using a plurality of seismic traces that are generated by a vibroseis source;
shifting the estimated FA picks to shot points that are within a predetermined window and have highest positive peaks to obtain enhanced FA picks;
optimizing the enhanced FA picks to refine coherence of trace-to-trace FA picks to obtain accurate FA picks; and
displaying a plot of the accurate FA picks.

2. The method of claim 1, further comprising
determining the estimated FA picks within an FA region, using one of Texture-Based Segmentation, Projection Onto Convex sets, and Coppens.

3. The method of claim 1, wherein the shifting the estimated FA picks further comprises
locating maximum points in a shot record and measuring distance of the maximum points from first zero or negative points.

4. The method of claim 3, wherein the shifting the estimated FA picks further comprises
adjusting the estimated FA picks in accordance with the measured distance to obtain the highest positive peaks.

5. The method of claim 4, wherein the shifting the estimated FA picks is such that the distance represents 25% of a signal period of a seismic trace.

6. The method of claim 3, wherein the optimizing the enhanced FA picks further comprises:
receiving consecutive traces of seismic data generated by the vibroseis source;
calculating vertical time differences between the enhanced FA picks in the consecutive traces;
assessing the vertical time differences, and eliminating the vertical time differences that exceed determined upper or lower limits;
selecting a most commonly occurring vertical time difference; and
calculating the common slope of the enhanced FA picks based on the selected vertical time difference.

7. The method of claim 6, wherein the upper limit is determined by dividing a total number of shot points in a trace (N_{S}) by a number of traces (N_{T}), where the lower limit (Lₗ) is computed by evaluating the vertical time difference between most prominent peaks in consecutive traces within a shot record.

8. The method of claim 6, further comprises:
assigning the common slope to a first enhanced FA pick in an initial trace;
repositioning all subsequent enhanced FA picks based on the common slope derived from the initial trace to determine a revised set of revised FA picks;
determining a cumulative sum of the revised FA picks which serves as a shot point score for a corresponding shot point;
repeating the assigning, repositioning, and determining for remaining FA picks until all the enhanced FA picks have been scanned and their corresponding cumulative sums have been computed and saved; and
selecting a set of enhanced FA picks corresponding to a highest cumulative sum as the accurate FA picks.

9. The method of claim 1, further comprises applying, by the vibroseis source, a sinusoidal vibration of continuously varying frequency during a sweep period.

10. The method of claim 1, the predefined window is set to a size to minimize errors during the shifting.

11. A non-transitory computer-readable storage medium including computer executable instructions, wherein the instructions, when executed by a computer, cause the computer to perform a method for First Arrival (FA) picking, the method comprising:
determining estimated FA picks using a plurality of seismic traces that are generated by a vibroseis source;
shifting the estimated FA picks to shot points that are within a predetermined window and have highest positive peaks to obtain enhanced FA picks;
optimizing the enhanced FA picks to refine coherence of trace-to-trace FA picks to obtain accurate FA picks; and
displaying a plot of the accurate FA picks.

12. The non-transitory computer-readable storage medium of claim 11, further comprising
determining the estimated FA picks within an FA region, using one of Texture-Based Segmentation, Projection Onto Convex sets, and Coppens.

13. The non-transitory computer-readable storage medium of claim 11, wherein the shifting the estimated FA picks further comprises:
locating maximum points in a shot record and measuring distance of the maximum points from first zero or negative points.

14. The non-transitory computer-readable storage medium of claim 13, wherein the shifting the estimated FA picks further comprises
adjusting the estimated FA picks in accordance with the measured distance to obtain the highest positive peaks.

15. The non-transitory computer-readable storage medium of claim 14, wherein the shifting the estimated FA picks is such that
the distance represents 25% of a signal period of a seismic trace.

16. The non-transitory computer-readable storage medium of claim 11, wherein the optimizing the enhanced FA picks further comprises:
receiving consecutive traces of seismic data generated by the vibroseis source;
calculating vertical time differences between the enhanced FA picks in the consecutive traces;
assessing the vertical time differences, and eliminating the vertical time differences that exceed determined upper or lower limits;
selecting a most commonly occurring vertical time difference; and
calculating the common slope of the enhanced FA picks based on the selected vertical time difference.

17. The non-transitory computer-readable storage medium of claim 16, wherein the upper limit is determined by dividing a total number of shot points in a trace (N_{S}) by a number of traces (N_{T}), where the lower limit (Lₗ) is computed by evaluating the vertical time difference between most prominent peaks in consecutive traces within a shot record.

18. The non-transitory computer-readable storage medium of claim 16, further comprises:
assigning the common slope to a first enhanced FA pick in an initial trace;
repositioning all subsequent enhanced FA picks based on the common slope derived from the initial trace to determine a revised set of revised FA picks;
determining a cumulative sum of the revised FA picks which serves as a shot point score for a corresponding shot point;
repeating the assigning, repositioning, and determining for remaining FA picks until all the enhanced FA picks have been scanned and their corresponding cumulative sums have been computed and saved; and
selecting a set of enhanced FA picks corresponding to a highest cumulative sum as the accurate FA picks.

19. The non-transitory computer-readable storage medium of claim 11, further comprises applying, by the vibroseis source, a sinusoidal vibration of continuously varying frequency during a sweep period.

20. The non-transitory computer-readable storage medium of claim 11, the predefined window is set to a size to minimize errors during the shifting.
